(19) United States
(12) Patent Application Publication
(10) Pub. No.: US 2009/0297680 A1
(43) Pub. Date: Dec. 3, 2009

(54) Method for homogeneously heating products

(76) Inventors: Peter Eisner, Freising (DE); Thomas Pfeiffer, Munchen (DE)

Correspondence Address: BREINER & BREINER, L.L.C., P.O. BOX 320160, ALEXANDRIA, VA, 22320-0160, US

(21) Appl. No.: 11/920,775

(22) PCT Filed: May 9, 2006
(86) PCT No.: PCT/DE2006/000795

§ 371 Date: Dec. 19, 2007

(30) Foreign Application Priority Data
May 23, 2005 (DE) 10 2005 024 152.2

(51) Int. Cl. A23L 3/16

(52) U.S. Cl. 426/521

(57) ABSTRACT

The present invention relates to a method for the homogeneous heating of products in which the products are heated in an alternating electromagnetic field, in particular a HF field, whereby first regions of the products are heated more intensely than second regions. The method is characterised in that the first regions are cooled at least before or during heating in the alternating field by additional means and/or measures for heat transfer and/or the second regions are heated by additional means and/or measures for heat transfer.

Homogenisation of the temperature profile in food, pharmaceutical and/or cosmetic products is achieved with the present method when heating in a high frequency alternating electromagnetic field.

### TECHNICAL SCOPE

The invention relates to a method for homogeneously heating products, in particular for homogenising the temperature profile in food, pharmaceutical and/or cosmetic products when they are heated in a high frequency alternating electromagnetic field.

Heating processes are required, among other things, for degerminating food or pharmaceutical products, thereby rendering them durable. Examples are pasteurising or sterilisation of foods, e.g. preserves in glasses or tins.

### STATE OF THE ART

Methods are known for heating products by means of heat exchangers or steam autoclaves. For example, milk is heated during pasteurisation in plate-type heat exchangers, kept for a defined time at pasteurisation temperature, then re-cooled. This method is established for liquid food and has proved satisfactory for some time.

Preserve tins or glasses containing vegetables, fruits, ready meals, hotpots or similar contents are almost exclusively heated in autoclaves, thereby rendering them durable. In the autoclaves hot steam is introduced at temperatures of above 120° C. The steam transfers the energy by condensation on the outside of the tins. From there heating takes place exclusively by heat conduction, so that it takes 30 to 60 minutes for the products to reach the desired final temperature in the centre of the tin.

A comparable situation arises in the heating of products in pieces in liquid matrices, for example pieces of meat in sauces, or fruits in fruit preparations or jams. These suspensions must be heated for a very long time because the desired temperature must also be reached inside the solid pieces and the heat is transferred by heat conduction. This means that the product has to be heated for a very long time and therefore considerable impairments in taste, vitamin content and in the consistency and colour of the products will occur. For this reason preserved foods tins have a very lower eating quality and undergo marked changes compared to the fresh raw product, e.g. the fruits.

Products which have to be heated for the purpose of pasteurisation, sterilisation or for other reasons include, among others:
Solids products and products in pieces in a surrounding liquid phase (e.g. fish or meat in sauces, fruits in water or juices, marmalade with pieces of fruit, fruit preparations for dairy products, liquids with protein pieces, etc.),
Packed foods, pharmaceutical products and cosmetics as liquid, solid or suspension in packaging materials such as blisters, films, tubes, sausage skins, natural casings, polymer packaging materials and others,
Viscous or pasty liquids and/or liquids containing solids, and pasts, sauces, creams, foams and other multi-phase systems which cannot be heated or can only be heated inhomogeneously in plate-type heat exchangers or tube-type heat exchangers because of their heterogeneous composition and/or solid and/or gas contents,
Substances which, on the heated heat exchanger surfaces, lead to encrustations, coatings, temperature damage and the like, and
Substances which are highly temperature sensitive, e.g. pharmaceutical products, infusion solutions, medical liquid food or other substances which must be heated particularly uniformly and gently.

The aforementioned substances and substance mixtures are referred to as products in this patent application.

A proposed solution for shortening the heating time and hence for improving the quality of the products involves rapid, penetrating heating with alternating electromagnetic fields. In addition to microwave heating, whose low depth of penetration of 5 to 20 mm is not sufficient for the uniform heating of the products mentioned, the use of a high frequency alternating field (HF heating) is particularly suitable for this purpose. Conventional HF heaters consist of two electrodes which are arranged in parallel and to which is applied an electrical alternating field with a frequency of 27.12 MHz and a voltage of 2 to 10 kV, for example. These fields are capable of penetrating deep into electrically conducting moist solids and suspensions and heating them. In the ideal case of a perfectly uniform characteristic of the electromagnetic field substances can be heated uniformly.

The purpose of the HF heating is the rapid, uniform and hence gentle heating of temperature-sensitive substances which cannot tolerate or poorly tolerate conventional heating in heat exchangers.

In many cases HF heating is chosen to heat products uniformly throughout their cross-section, e.g. for the purpose of pasteurisation, sterilisation or preparation. However, it is shown that in HF heaters which generate a homogeneous electromagnetic field in air, extreme field and temperature inhomogeneities occur during operation with the products mentioned, which eliminates the advantage of penetrating heating and may result in considerable product damage.

For example, considerable over-temperatures occur in the case of packed solids, particularly on the edges of the packaging materials, on the outside and on extremely thin points on the products. Overheating of and damage to the products may occur at these points. The inner regions of the solids are in this case only inadequately heated despite the high, product-damaging temperatures of the outer regions.

The same effects may also be observed when HF heater tubes are used in which electrodes are fitted to a non-conducting tube (e.g. of quartz glass). Highly viscous, pasty liquids or suspensions can be fed through the tube for heating. Here considerable damage is seen, mainly on the tube walls. Marked overheating occurs here. Despite the high temperatures on the tube wall, inadequate temperatures are reached in the centre of the tube. As a result of this similar problems occur with temperature inhomogeneities in the tube cross-section and with the formation of coatings on the tube wall as in conventional tube-type heat exchangers heated on the outside.

A further disadvantage of inhomogeneous heating results from the variation in electrical conductivity at the hotter points. The hot points often have increased electrical conductivity, which in many cases means that they are heated even more quickly in the HF field. This process may lead to the formation of so-called “hot spots”, since the hot points are heated disproportionately. The temperature inhomogeneities are therefore increasingly intensified.

Despite the attempts to homogenise the electrical field and energy density between the electrodes by adapting the electrode geometry, no success has been achieved in preventing overheating and temperature inhomogeneities using the known methods of prior art. The temperatures are almost always substantially increased on the outsides of the products, whilst at points inside the products far lower temperatures are frequently present. This applies particularly to solids which, when packed for example, are heated in the HF field, and to highly viscous liquids and suspensions in HF heater tubes.

The disadvantages of the HF heaters of prior art may therefore be summarised as follows:
inhomogeneous heating over the product or tube cross-section;
generation of an inhomogeneous HF field, since hotter points in the product are always heated more quickly;
temperature damage at some points of the product, in many cases on the outsides.

The object of the present invention consists in indicating a method with which products can be heated more homogeneously. In particular, the method is intended to homogenise the temperature distribution in the products, thereby reducing or preventing temperature inhomogeneities.

### DESCRIPTION OF THE INVENTION

The object is achieved with the method according to Claim 1. Advantageous embodiments of the method constitute the subject matter of the dependent claims, or may be deduced from the embodiments described in the following.

In the proposed method for homogeneous heating of products, the products are subjected to an alternating electromagnetic field, preferably a HF field. In this case HF field refers to an electromagnetic field in the frequency range of between approximately 10 kHz and approximately 300 MHz, in which the products are heated by dielectric heating. The frequencies 13.56 MHz, 27.12 MHz or 40.68 MHz, which are released for industrial applications, are preferably used. Generally, however, other frequencies are also suitable for HF heating. The method is characterised in that first regions of the products, which are heated more intensely by the alternating field than second regions, are cooled by additional means and/or measures for heat transfer at least before or during heating in the alternating field, and/or in that the second regions are heated by additional means and/or measures for heat transfer.

In the inventive method a temperature homogenisation is therefore superimposed on the heating of the products. in the alternating electrical field, which homogenisation is achieved by additional specific heat transfer by convection or heat conduction.

The temperature homogenisation is achieved by additional heating of the colder points of the products and/or by additional cooling of the hot points of the products. In a particularly advantageous embodiment of the invention this process takes place directly in the alternating field, preferably a HF field, to which reference is made, by way of example, in the embodiments described below.

The additional heating and/or cooling of the products can be achieved in different ways.

In an advantageous embodiment of the inventive method the excess heat is discharged in a heater tube, in the product or from the product or packaging outsides by transfer of the heat into a suitable heat carrier. This heat carrier may, for example, be thermal oil, water or the like, which either circulates the product directly or which is separated from the product by heat exchanger surfaces or by the packaging material.

The products or the packed products or heater tubes may therefore be circulated with water on the outside. This can be achieved, for example, by the use of a double jacket tube as heater tube or by placing the packed products in a water bath or circulating them with a water flow. Here the water should have a lower temperature or at most the same temperature as the maximum temperature of the product aimed for. This ensures that heat is discharged from zones with an over-temperature. The contact points between the tube wall or the product packaging material and the product are cooled by reducing the electrical conductivity of the product point and achieving temperature homogenisation. So-called hot spots and local overheating may be prevented at these points. Besides water, other media suitable as heat carriers may of course be used.

In a further embodiment of the inventive method a liquid or gaseous medium is used for transferring the heat, which medium is not or only slightly heated in the HF field. Distilled or deionised water is particularly suitable as an inert liquid in this sense. This water is hardly subjected to any heating in a HF field. It is therefore possible to discharge heat directly in the region of the HF field very quickly from hot zones of the product into a cooling medium with a high heating capacity without heating the cooling medium through the HF field itself.

In a particularly advantageous embodiment of this application a packed product is guided through a water bath of a defined temperature with deionised or distilled water. A packed product, which is to be heated to 90° C., for example, may therefore be guided initially through a cooled water bath that has a temperature of 40° C., for example. This measure enables thin regions of the product and the outer zones to be cooled to values far below 90° C., whilst the product in the water bath is loaded with the alternating electrical field, in particular with HF radiation. The inner regions, on the hand, are not cooled, so that homogeneous heating may generally be obtained up to a temperature of 90° C. If necessary the product can be fed into a water bath after leaving the HF field, which bath has a temperature of 90° C. Here the outer regions are then heated to the desired target temperature, and maintained at that temperature. Despite rapid heating this process enables temperatures higher than 90° C. to prevail in the product.

It is also possible, and in many case it may be advantageous, for heat to be introduced into colder regions, e.g. into the centre of the heater tube, by means of heat carrying media. For this purpose heat exchanger tubes, for example, may be introduced into the centre of the heater tube, through which tubes flows hot water, for example. This measure also enables the temperature distribution in the product to be homogenised. The introduction of a material into the interior of the tubes or products, which material is heated extremely quickly in the HF field, e.g. a metal, is another suitable method. Heat can therefore be generated specifically in the centre of the product.

A further possibility of avoiding over-temperatures consists, when heating products with a liquid proportion, in reducing the system pressure to a value at which the boiling temperature of the liquid proportion is approximately equal to the target temperature to which the product is to be heated. If a pressure of 200 hPa (200 mbar) is generated in an aqueous system, the boiling temperature of the water is reduced to 60° C. If it is necessary for the product temperature values not to exceed 60° C., for example, and if the product composition permits this, small volumes of the product can therefore be specifically evaporated in hot zones of the product. The steam can then flow to colder product points in the heater tube or in the packaging material, which is comparable to the steam cavitation in conventional heating on hot surfaces. There the steam condenses directly on the cold product points, heating them. Because of the rapid condensation bursting of the packaging material or an increase in pressure in the heater tube is avoided. Also as a result of this measure, a heat transfer by heat conduction and convection is imposed on radiation heating and temperature homogenisation is achieved.

### EXEMPLARY EMBODIMENT

### Heater Tube for Liquid Suspensions

100 kg of a fruit preparation, consisting of strawberries, sugar and gelling agent, were fed through a HF heater tube. A quartz glass tube was used as the heater tube, on which aluminium electrodes were fitted on the outside, to which electrodes a HF field was applied. In a first test the fruit preparation was pumped through the HF field. Because of the high product viscosity and the associated longer holding time of the product, an over-temperature of 30° K, compared with the core flow, was generated on the inside of the quartz glass tube.

For adequate heating of the product in the core flow the feed rate had to be adjusted so that a temperature of 70° C. was obtained in the interior. Temperatures of over 100° C. were in this case obtained on the tube wall, which considerably impaired the quality of the fruit preparation.

In a second test, which was carried out according to the present method, a double jacket quartz glass tube was used. Fruit preparation was again fed into the tube interior. Distilled water at 60° C. flowed through the outer jacket. Excess heat could be discharged from the tube wall by the distilled water so that the product was heated homogeneously to 70° C. inside the tube and product parts did not become hotter on the outer wall. Homogeneous pasteurisation was achieved.

### EXEMPLARY EMBODIMENT

### Heater for Packed Foods

In the first embodiment the heater consists of two parallel plate electrodes measuring 40 cm×40 cm at a distance of 40 cm from each other. By applying a voltage of 10 kV and a frequency of 27.12 MHz to the electrodes a high frequency field is generated in the air space between the electrodes. A 1000 ml glass for preserves was filled with fruits in the sugar icing and sealed with a screw cap. The preserve glass was introduced into the high frequency field and heated from 20° C. to 90° C.

The rate of heating the fruit mixture was low. Furthermore, high temperatures of over 100° C. were obtained at the bottom of the glass and on the shoulder for the screw edge.

In a second embodiment the space between the electrodes was filled with a cuboid-shaped water basin whose walls and bottom are constructed of electrically insulating materials, e.g. boron silicate glass. The water basin was filled with deionised water at a temperature of 70° C. The electrode voltage was 10 kV, with a frequency of 27.12 MHz. A preserve glass in the same design and with the same filling as described in the first embodiment was introduced into the water bath and heated from 20° C. to 90° C. in 120 seconds. The heating rate was higher by a factor of approximately 100 than in the first embodiment of the heater. The temperature increases on the bottom and on the shoulder of the glass could be kept far lower than in the first heater embodiment because of the cooling action of the water bath.

The method in the second embodiment is also suitable for products in plastic film bags, in plastic beakers and in plastic buckets.

1. A method for homogeneous heating of products comprising heating the products in an alternating electromagnetic field through which first regions of the products are heated more intensely than second regions, wherein the first regions are cooled at least before or during said heating in the alternating field by additional heat transfer means and/or the second regions are heated by additional heat transfer means.

2. The method according to claim 1, wherein the first regions and/or the second regions are brought into contact with a heat carrier as said heat transfer means.

3. The method according to claim 2, wherein the heat carrier is a liquid medium or gaseous medium that circulates the products.

4. The method according to claim 1, wherein the first regions and/or the second regions are brought into contact with at least one heat exchanger as said heat transfer means, in which heat exchanger flows a heat carrier.

5. The method according to claim 1, wherein said heating of the products is carried out in a heater tube comprising a double jacket tube with an inner volume and an outer volume, wherein the products are introduced into the inner volume and a heat carrier flows through the outer volume.

6. The method according to claim 1, wherein said heating of the products is carried out in a heater tube comprising a double jacket tube with an inner volume and an outer volume, wherein the products are introduced into the outer volume and a heat carrier flows through the inner volume.

7. The method according to claim 1, wherein the products are packed products which are introduced into a liquid medium as said heat transfer means.

8. The method according to claim 7, wherein the liquid medium is a water bath.

9. The method according to claim 2, wherein the heat carrier comprises a medium which is not heated or is at least heated to a lower temperature than the products are heated by the alternating field.

10. The method according to claim 2, wherein the heat carrier comprises a medium which is heated to a higher temperature than the products are heated by the alternating field.

11. The method according to claim 2, wherein the heat carrier is tempered.

12. The method according to claim 1, wherein said heating of the products is carried out in a heater tube on whose axis one or a plurality of elements of a solid material are arranged, which said material heats up in the alternating field to a temperature higher than that of the products present in a common region thereto.

13. The method according to any one of claims 1 to 12, wherein the products include a liquid proportion and are heated to a predetermined temperature at a pressure at which boiling temperature of the liquid proportion is approximately equal to the predetermined temperature.
